(19) United States
(12) Patent Application Publication
(10) Pub. No.: US 2026/0013489 A1
(43) Pub. Date: Jan. 15, 2026

(54) INSECT REPELLENT DEVICE AND METHOD

(71) Applicant: United Industries Corporation, Earth City, MO (US)

(72) Inventors: Alex J. Wall, St. Louis, MO (US); Hemant Betrabet, Mount Pleasant, WI (US); Amber Martin, Wentzville, MO (US)

(73) Assignee: United Industries Corporation, Earth City, MO (US)

(21) Appl. No.: 19/334,241

(22) Filed: Sep. 19, 2025

Related U.S. Application Data
(63) Continuation of application No. PCT/US2024/020592, filed on Mar. 19, 2024.
(60) Provisional application No. 63/453,290, filed on Mar. 20, 2023.

(51) Int. Cl. A01M 1/20; A01M 29/00; A01N 25/18; A01P 17/00

(52) U.S. Cl. CPC A01M 1/2066; A01M 29/00; A01N 25/18; A01P 17/00

(57) ABSTRACT

A non-powered insect repellent device includes a heating element, a reservoir, and an activating member. The heating element includes a chemical compound configured to generate heat via an exothermic reaction when exposed to air. The reservoir is coupled with the heating elements and includes a dosing member and a container. The container included a cavity containing a volume of insect repellent material. The activating member is coupled with the heating element and the reservoir. With the activating member in a closed position, the activating member prevents air from passing to the chemical compound and prevents the insect repellent material from being dispensed from the cavity to the dosing member. With the activating member in the open position, air passes through the first opening to the chemical compound to facilitate the exothermic reaction and the insect repellent material is dispensed to the dosing member.

### CROSS-REFERENCE TO RELATED PATENT APPLICATIONS

The present application is a continuation of PCT/US2024/020592, entitled “INSECT REPELLENT DEVICE AND METHOD,” filed Mar. 19, 2024, which claims the benefit of and priority to U.S. Provisional Patent Application No. 63/453,290, entitled “INSECT REPELLENT DEVICE AND METHOD,” filed on Mar. 20, 2023, the entirety of each of which is incorporated by reference herein.

### BACKGROUND

The present disclosure relates generally to insect repellent devices. More specifically, the present disclosure relates to non-powered insect repellent devices. Insect repellent devices are used to repel insects that would otherwise create a nuisance or potentially serve as carriers of various diseases.

### SUMMARY

One exemplary embodiment relates to a non-powered insect repellent device. The non-powered insect repellent device includes a heating element, a reservoir, and an activating member. The heating element includes a chemical compound and a first opening. The chemical compound is configured to generate heat via an exothermic reaction when exposed to air via the first opening. The reservoir is coupled with the heating element. The reservoir includes a dosing member and a container. The container includes a second opening and a cavity containing a volume of insect repellent material. The second opening is configured to selectively fluidly couple the cavity with the dosing member. The activating member is coupled with the heating element and the reservoir. The activating member configured to move between a closed position and an open position. With the activating member in the closed position, the activating member is configured to prevent air from passing through the first opening to the chemical compound and to prevent the insect repellent material from being dispensed through the second opening to the dosing member. With the activating member in the open position, air is permitted to pass through the first opening to the chemical compound to facilitate the exothermic reaction and the insect repellent material is dispensed through the second opening to the dosing member.

Another exemplary embodiment relates to a non-powered insect repellent device. The non-powered insect repellent device includes a plurality of stacked heating elements, a container, a dosing member, a first activating member, and a second activating member. The plurality of stacked heating elements each include a chemical compound configured to generate heat via an exothermic reaction when exposed to air via a first opening. The container is thermally coupled with the plurality of stacked heating elements. The container includes a cavity containing a volume of insect repellent material and a second opening. The insect repellent material includes a metofluthrin solution. The dosing layer includes an absorbent material. The dosing layer is coupled with the container and configured to receive at least a portion of the volume of insect repellent material from the cavity via the second opening. The first activating member is coupled to the first opening and configured to selectively permit air to flow to the outer-most heating element via the first opening to facilitate an exothermic reaction. The second activating member is coupled to the second opening and configured to selectively dispense insect repellent material from the cavity to the dosing layer via the second opening.

Yet another exemplary embodiment relates to a non-powered insect repellent device. The housing defines a cavity. The heating element incudes a chemical compound configured to generate heat via an exothermic reaction when exposed to air via a first opening. The reservoir is thermally coupled with the heating element. The reservoir includes a dosing member, a container cavity containing a volume of insect repellent material, and a second opening. The dosing member is positioned to receive at least a portion of the volume of insect repellent material from the container cavity via the second opening. The activating member is coupled to the first opening and the second opening. The activating member is configured to selectively permit air to flow to the outer-most heating element via the first opening to facilitate an exothermic reaction. The activating member is further configured to selectively dispense insect repellent material from the container cavity to the dosing layer via the second opening. The insulative layer surrounds at least a portion of the heating element. The heating element, the reservoir, the insulative layer, and at least a portion of the activating member are positioned within the cavity of the housing.

The invention is capable of other embodiments and of being carried out in various ways. Alternative exemplary embodiments relate to other features and combinations of features as may be recited herein.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of an insect repellent device, according to an example embodiment.

FIG. 2 is an exploded view of an insect repellent device, according to an example embodiment.

FIG. 3 is a cross-section view of a heater element of an insect repellent device taken along line A-A of FIG. 1, according to an example embodiment.

FIG. 4 is a cross-section view of a heater element of an insect repellent device taken along line A-A of FIG. 1, according to an example embodiment.

FIG. 5 is a cross-section view of a reservoir of an insect repellent device taken along line A-A of FIG. 1, according to an example embodiment.

FIG. 6 is a cross-section view of a reservoir of an insect repellent device taken along line A-A of FIG. 1, according to an example embodiment.

FIG. 7 is a cross-section view of an insect repellent device taken along line A-A of FIG. 1, according to an example embodiment.

FIG. 8 is a cross-sectional view of an insect repellent device, according to an example embodiment.

FIG. 9 is a cross-sectional view of an insect repellent device, according to an example embodiment.

FIG. 10 is a perspective view of a housing for an insect repellent device, according to an example embodiment.

### DETAILED DESCRIPTION

Before turning to the figures, which illustrate the example embodiments in detail, it should be understood that the present application is not limited to the details or methodology set forth in the description or illustrated in the figures. It should also be understood that the terminology is for the purpose of description only and should not be regarded as limiting.

Referring to the figures generally, the various example embodiments disclosed herein relate to systems, apparatuses, and methods for repelling insect. For example, the present disclosure relates to an insect repellent device and methods. The insect repellent device can be non-powered such that electricity, batteries, gasoline, or other powered sources are not required to activate an insect repellent. In one example embodiment, the device combines a volatile insect control chemical and a non-powered heating element, such that when initiated, the non-powered heating element will heat the substrate to expedite dispensing (e.g., vaporizing or emanating) of the insect repellent (e.g., a volatile insect control chemical). For example, the insect repellent device can include a heating element that can generate heat through an exothermic chemical reaction. The generated heat can activate or vaporize the insect repellent such that the insect repellent can be distributed from a substrate containing the insect repellent. The insect repellent device can be single-use device that, once used, can be recycled or otherwise discarded. For example, the insect repellent device can include components that are recyclable, bio-degradable, or compostable such that the insect repellent device can be recycled or discarded in an environmentally conscious manner after it is used.

The insect repellent device can include a heating element and a reservoir. The heating element can be configured to generate heat with a chemical compound of the heating element activated. For example, the heating element can include a zinc-based chemical compound that can undergo an exothermic (e.g., heat-generating) reaction with the heating element activated. The zinc-based chemical compound of the heating element can be activated by exposing the chemical compound to oxygen (e.g., air). For example, the heating element can include an outer member, such as a pouch (e.g., shell, membrane, bag, sleeve, or other member) to encapsulate the chemical compound, where the pouch can include at least one opening to selectively allow oxygen to flow contact the chemical compound to initiate an exothermic reaction. For example, the opening can be opened (e.g., by pulling an activating tab or some other activating device) to expose a cavity of the pouch to oxygen and initiate an exothermic reaction. The chemical compound can be prevented from reacting in an exothermic fashion with the opening of the pouch closed. The heating element can be coupled with or positioned proximate to the reservoir such that the heating element can provide heating energy to the reservoir.

The insect repellent device can include the reservoir to store and/or emanate a volume of an insect repellent (e.g., an insect repellent substance, liquid, gel, or other material). For example, the reservoir can include a container and a dosing member. The insect repellent can be a liquid, semi-solid, or other substance. For example, the insect repellent can be liquid Metofluthrin or some other insecticide or insect repellent. The insect repellent can be contained within a cavity of the container. The container can be a rigid or flexible structure. For example, the container can be a bladder, pouch, sack, or other flexible member defining the cavity. The container can include an opening to selectively dispense the insect repellent from the cavity of the container. For example, the opening can be opened (e.g., by pulling an activating tab or some other activating device) to release at least a portion of the volume of the insect repellent from the cavity of the container. The insect repellent can be retained within the cavity of the container with the opening of the container in a closed position. The opening of the container can selectively provide an amount of insect repellent to the dosing member with the opening in an open position. The dosing member can be a porous member that at least partially surrounds the container. For example, the dosing member can be or include a fabric material to absorb insect repellent dispensed from the cavity container. The dosing member can wick the insect repellent away from the opening of the container. The dosing member can emanate the insect repellent. For example, the dosing member can emanate the insect repellent into a surrounding environment with the dosing member exposed to heat, such as heating energy generated by the heating element.

The insect repellent device can include an activating member. The activating member can be configured to selectively open the opening of the heating element to initiate an exothermic reaction of the chemical compound of the heating element. The activating member can be configured to selectively open the opening of the container to release an amount of insect repellent to the dosing member. For example, a single activating member can simultaneously open both the opening of the heating element and the opening of the container. In some examples, a first activating member can open the opening of the heating element, and a second activating member can open the opening of the container. The activating member can be a pull-tab having at least one end adhered the container or heating element to cover the opening. When a force is applied by a user (e.g., when the pull-tab is pulled), the end of the activating member can be separated from the container or heating element to open the relevant opening. In some example, the activating member can be a sharp object (e.g., a pin or tack) to puncture the container and cause an amount of insect repellent to be dispensed.

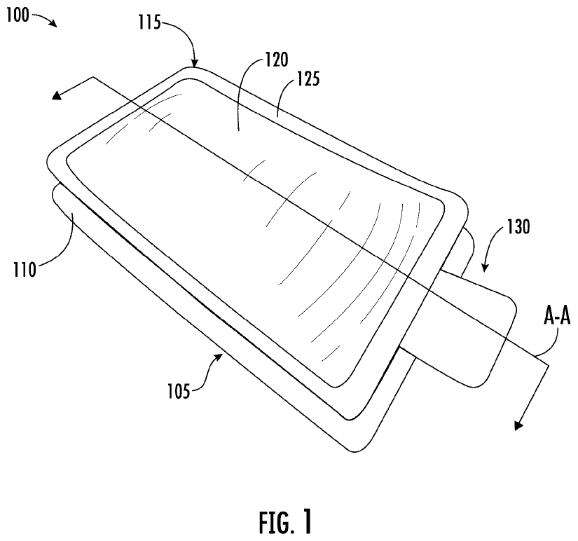

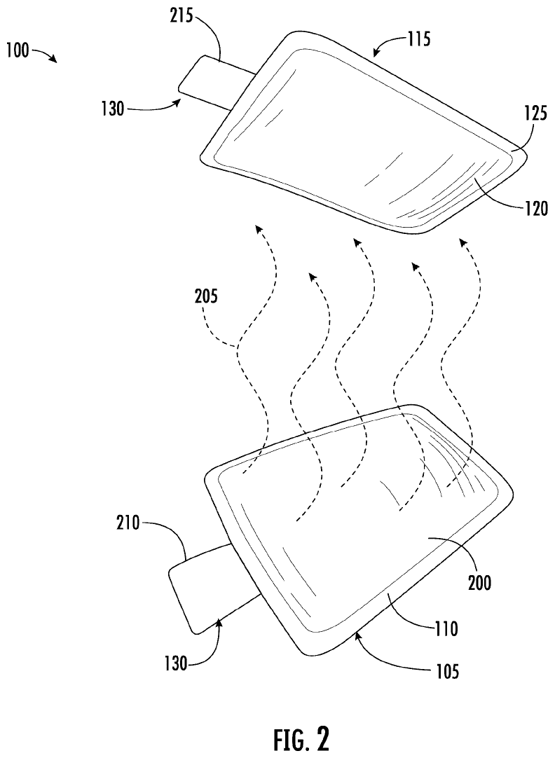

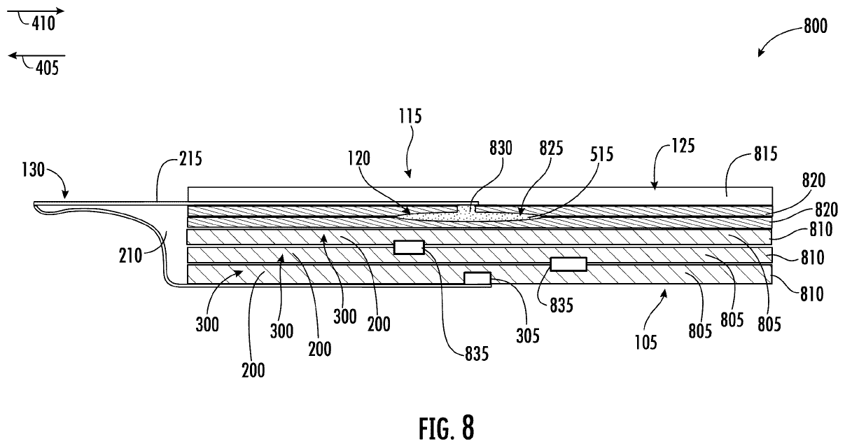

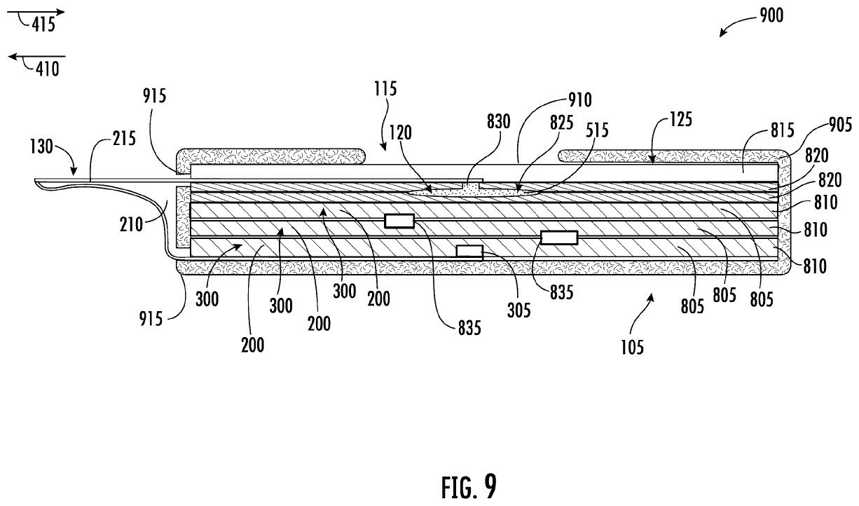

Referring generally to FIGS. 1-2, among others, an insect repellent device 100 is shown. The insect repellent device 100 can include a heating element 105, a reservoir 115, and an activating member 130. The heating element 100 can include an outer member, such as a pouch 110. The heating element 105 can include a chemical compound 200 positioned within the pouch 110. The heating element 105 can generate heating energy 205 via a chemical reaction, such as an exothermic reaction. The heating element 105 can be coupled with or positioned adjacent to the reservoir 115. The reservoir 115 can include a container 120 and a dosing member 125. The reservoir 115 can include the container 120 at least partially covered (e.g., enveloped, surrounded) by the dosing member 125. For example, the dosing member 125 can define a wicking or absorbent substrate 500. The container 120 can be positioned within the substrate 500. The container 120 can contain an amount of some substance (e.g., an insect repellent 510 as shown in FIG. 5 and as discussed below). The container 120 can selectively provide an amount of substance to the dosing member 125. The dosing member 125 can disperse or emanate the amount substance provided by the container 120. The activating member 130 of the insect repellent device 100 can be configured to initiate a heat-generating reaction (e.g., an exothermic reaction) of the heating element 105. The activating member 130 can be configured to cause the container 120 to provide an amount of substance to the dosing member 125. For example, the activating member 130 can include a first pull-tab 210 to activate the heating element 105 and a second pull-tab 215 configured to cause the substance to be released from the container 120, as is discussed in detail below. In other embodiments, such as those shown in FIGS. 8-10 and discussed below, the insect repellent device can include multiple heating elements 105 (e.g., heating element 805), an insulative member (e.g., insulative member 905), a container defined by multiple layers (e.g., sheets 820), or a housing (e.g., housing 1000), or other components.

As shown in FIGS. 2-4, among others, the heating element 105 can include the pouch 110 to store (e.g., house or contain) an amount of the chemical compound 200. The chemical compound 200 can generate heating energy via an exothermic reaction or some other reaction (e.g., an oxidation reaction). The pouch 110 can define a cavity 300. The chemical compound 200 can be positioned within the cavity 300 of the pouch 110. The pouch 110 can comprise a mixed polymeric material. The pouch 110 can include some other material, such as a natural fiber or organic material, a metallic material, or some other material. For example, the pouch 110 can comprise a blend of polymeric material and natural fiber materials. The pouch 110 can include an oxygen-impermeable material that prevents oxygen from passing into the cavity 300. For example, the pouch 110 can prevent oxygen from flowing into the cavity 300 and reacting with the chemical compound 200, thereby preventing an exothermic reaction or other reaction from initiating unintentionally. The pouch 110 can also be waterproof or can create a barrier preventing other gases or chemicals from permeating the pouch 110 or entering the cavity 300.

The heating element 105 can include a chemical compound configured to generate heating energy. For example, the heating element 105 can include a chemical compound 200 that can undergo an exothermic chemical reaction to generate heating energy 205. The chemical compound 200 can include a zinc-based chemistry, such as a zinc-based chemistry that is not pre-oxidized. For example, the chemical compound 200 can include zinc, among other chemicals, where the zinc can react with oxygen (e.g., oxygen present in air) in an exothermic reaction to produce the heating energy 205. The heating element 105 can include the chemical compound 200 including an iron based chemistry, a magnesium-based chemistry, or some other chemistry. The heating element 105 can include the chemical compound 200 that can be activated by oxygen in order to initiate an exothermic reaction to produce the heating energy 205. The heating energy 205 can radiate from the heating element 105 to surrounding objects or areas (e.g., to the reservoir 115). The heating element 105 can include a particular volume, weight, or amount of the chemical compound 200 to generate the heating energy 205 to reach a desired temperature and/or to generate heating energy for a desired duration. For example, the chemical compound 200 can undergo an exothermic reaction to increase a temperature of the heating element 105 or a portion of the heating element 105 (e.g., a center, a surface, or some other portion) to 90° C., 70-100° C., less than 70° C., or greater than 100° C. The chemical compound 200 can undergo an exothermic reaction to generate heating energy 205 for at least two hours, from 1-2 hours, for more than two hours, or for less than one hour. For example, the heating element 105 can include the chemical compound 200 having a particular chemistry and/or a particular amount of the chemical compound 200 to generate the heating energy 205 to reach a temperature of approximately 90° C. (e.g., +5° C.) for a time of approximately two hours (e.g., +15 minutes). In some embodiments, the amount of certain chemicals or compounds within the chemical compound 200 can be selected based on a desired temperature profile or heating time profile. For example, certain chemistries or proportions of certain chemicals within the chemical compound 200 can cause a rapid temperature increase or a slow (e.g., gradual) temperature increase. Certain variations of the chemical compound 200 can facilitate an exothermic reaction having a greater temperature profile (e.g., higher maximum temperatures), but a shorter time profile (e.g., an oxidation or exothermic reaction will cease in a shorter amount of time), while other variations of the chemical compound 200 can result in a greater time profile but a lesser temperature profile. Accordingly, the chemical compound 200 of the heating element 105 can be selected based on specific temperature or time requirements for the particular insect repellent device 100.

The heating element 105 can be or include a sheet or pad form factor. For example, the heating element 105 can include a relatively small amount of chemical compound such that the heating element 105 include a sheet, pad, or pouch form factor having a thickness of one centimeter, less than one centimeter, 0.5 centimeters, or 1-2 centimeters. The heating element 105 can have a small form factor and a high energy concentration (e.g., heating elements generating a relatively high amount of heating energy by weight or volume) relative to a heating element 105 using a different chemical compound (e.g., an iron-based chemical compound).

Although discussed above as including a zinc-based chemistry configured to cause an exothermic reaction, the heating element 105 can include the chemical compound 200 having some other than a zinc-based chemistry or some chemistry excluding zinc that can undergo (e.g., cause, prompt, experience, facilitate) an exothermic reaction or oxidation reaction to generate heating energy. For example, the heating element 105 can have the chemical compound 200 including zinc powder, copper sulfate, and water. For example, zinc powder or copper sulfate can be activated by water to create an oxidation reaction that generates heating energy. The chemical compound 200 can include calcium oxide and an electrolyte solution or water. For example, calcium oxide can be activated by an electrolyte solution to create an exothermic reaction. The chemical compound 200 can include potassium salts and glycerol. For example, potassium salts such as potassium permanganate can be activated by glycerol to create an oxidation reaction. The chemical compound 200 can be configured to produce a catalytic reaction. The chemical compound 200 can include have activated carbon. The chemical compound 200 can include a chemistry including aluminum powder and silica. The chemical compound 200 can be configured to produce an acid and base reaction. The chemical compound 200 can have a chemistry including calcium salts and water.

In some examples, the chemical compound 200 can include a hydrogel material. For example, the chemical compound 200 can include hydrogel beads that include polymeric materials such as superabsorbent polymers. The hydrogel beads can be saturated with moisture (e.g., water). An exothermic reaction of the chemical compound 200 can cause the hydrogel material to evaporate and provide water to the heating element 105 or the pouch 110. The moisture can be consumed during the exothermic reaction to prolong the exothermic reaction or increase a maximum temperature of the exothermic reaction. In some examples, the moisture contained in hydrogel material can provide fuel for the exothermic reaction. For example, some heating elements can be activated by water, in which case the hydrogel beads can evaporate as the heating element is heated to provide additional water to continue (e.g., increase, prolong, extend) an exothermic reaction. In some instances, the exothermic reaction can be started by providing other water (e.g., water not in hydrogel form), which initiates an exothermic reaction, which can cause the hydrogels to evaporate, which can cause the hydrogels to provide additional water to the heating element to continue the exothermic reaction.

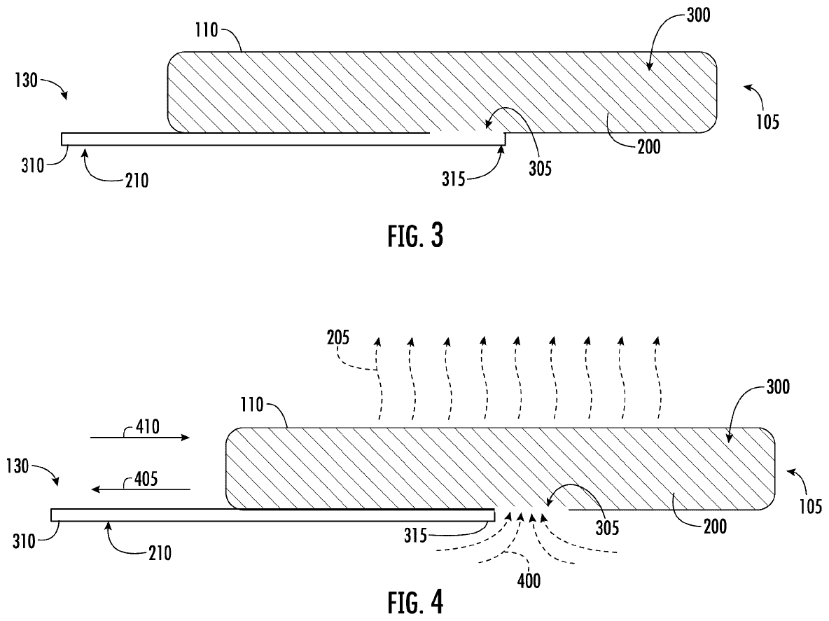

The insect repellent device 100 can include the heating element 105 to generate heating energy 205 with the chemical compound 200 activated. For example, and as discussed above, the chemical compound 200 can be configured to undergo an exothermic reaction with the chemical compound exposed to oxygen or some other chemical. As depicted in FIGS. 3, 4, and 7, among others, the heating element 105 can include the pouch 110 having at least one opening 305 to selectively allow air (e.g., oxygen) to contact the chemical compound 200 within the pouch 110. For example, the opening 305 can be one or more an apertures, holes, vents, one-way valves, or perforations that can allow air to flow into the cavity 300 of the pouch 110. Air flowing into the cavity 300 via the opening 305 can initiate an exothermic reaction of the chemical compound 200. For example, as noted above, the chemical compound 200 can be a zinc-based chemical compound that, when exposed to air, can react with oxygen in the air in an exothermic manner to generate heating energy 205. The heating energy 205 can be produced as the zinc within the chemical compound 200 reacts with air flowing into the cavity 300 via the opening 305 until the zinc within the chemical compound 200 is consumed (e.g., when all of the zinc has reacted with oxygen). The exothermic reaction of the chemical compound 200 can continue while the opening 305 is open (e.g., uncovered, revealed, unobstructed, unblocked) such that air can flow into the cavity 300. The exothermic reaction can be prevented or stopped with the opening 305 closed (e.g., covered, obstructed, blocked) such that air cannot flow into the cavity 300 via the opening 305.

The insect repellent device 100 can include the activating member 130 to selectively allow air to flow into the cavity 300 via the opening 305. For example, as depicted in FIGS. 2-4, the activating member 130 can include at least one pull-tab 210. The pull-tab 210 can include a first end 310 (e.g., segment, portion, side) and a second end 315 (e.g., segment, portion, side). The first end 310 can extend away from the pouch 110 of the heating element 105. The second end 315 can be coupled with the pouch 110. For example, the second end 315 can be coupled with the pouch 110 to cover the opening 305. The second end 315 of the pull-tab 210 can be coupled with the pouch 110 over the opening 305 such that air cannot flow into the cavity 300 of the pouch 110 via the opening 305 with the second end 315 coupled with the pouch 110. For example, the second end 315 can be coupled with the pouch via an adhesive or with a gasket or seal positioned between the second end 315 and the pouch 110 such that an air-tight (e.g., oxygen-impermeable) seal between the second end 315 of the pull-tab 130 and the pouch 110 can be created. The air-tight seal between the pull-tab 210 and the pouch 110 can prevent air from flowing into the cavity 300 and interacting with the chemical compound 200. For example, the chemical compound 200 can be prevented from reacting with oxygen in an exothermic manner because the second end 315 can prevent air from entering the cavity 300 via the opening 305.

The pull-tab 210 can be removably coupled with the pouch 110. For example, the second end 315 of the pull-tab 210 can be detachably coupled with the pouch 110 such that the pull-tab 210 can at least partially separate from the pouch 110 to allow air to flow into the cavity 300 of the pouch 110 via the opening 305. For example, as depicted in FIG. 3, among others, the pull-tab 210 can be in a first position with the second end 315 coupled with the pouch 110 and covering the opening 305 to prevent air from flowing into the cavity 300 via the opening 305. The chemical compound 200 within the cavity 300 can be sealed and unexposed to air with the pull-tab 210 in the first position. The pull-tab 210 can be moved from the first position to a second position. For example, the pull-tab 210 can be moved from the first position to the second position, where the second position can include the second end 315 of the pull-tab 210 at least partially separated from the pouch 110 or at least partially separated from the opening 305. As depicted in FIG. 4, among others, the second end 315 of the pull-tab 210 can be moved away from or separated from the opening 305 of the pouch 110 with the pull-tab 210 in the second position. For example, the pull-tab 210 can move in the direction 405 or some other direction to move or separate the second end 315 from the opening 305. Air, such as air 400, can flow into the cavity 300 via the opening 305 with the pull-tab 210 in the second position. For example, a user or operator can grasp the first end 310 of the pull-tab 210 and apply a force (e.g., a tensile force, a pulling force) to the pull-tab 210 in the direction 405 to separate or move the second end 315 from the opening 305 to allow air to flow into the cavity 300 and consequently initiate an exothermic reaction of the chemical compound 200. The user or operator can push the first end 310 of the pull-tab in a second direction 410 move the second end 315 over the opening 305 to prevent air from flowing into the cavity 300 and to consequently stop or prevent an exothermic reaction of the chemical compound 200.

The activating member 130 can include some other mechanism, component, or device to selectively allow air to flow into the cavity 300 via the opening 305. For example, the activating member 130 can include a screw-actuated valve that can prevent air from flowing through the opening 305 with a screw in a tightened position and allow air to flow through the opening 305 with the screw in a loosened position. The activating member 130 can include a rotatable disc or knob that can prevent air from flowing through the opening 305 with a disc in a first rotational position and allow air to flow through the opening 305 with the disc in a second rotational position. The activating member 130 can include a pin, tack, or other sharp object to selectively pierce the pouch 110 and to create the opening 305. For example, rather than covering a pre-existing opening, the activating member 130 can include a sharp object to pierce the pouch 110 and create the opening 305 to allow the air 400 to flow into the cavity 300. The sharp object of the activating member 130 can be actuated by a user depressing a portion of the activating member 130 to pierce the pouch 110.

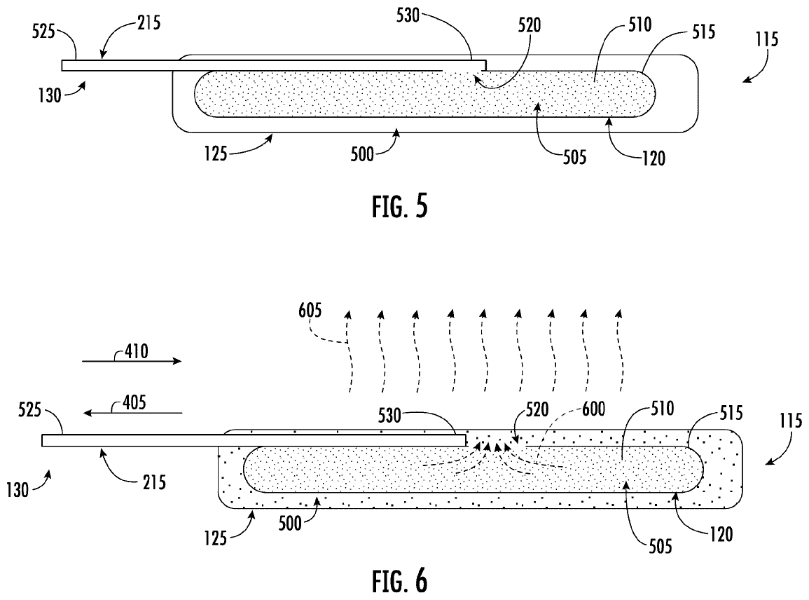

The insect repellent device 100 can include the reservoir 115 to store or dispense an amount of insect repellent. For example, as depicted in FIGS. 5-6, among others, the reservoir 115 can store a volume of the insect repellent 510, dispense an amount (e.g., the entire volume or a portion thereof) of the insect repellent 510, and cause the dispensed amount of insect repellent to be emanated from the insect repellent device 100. The volume of insect repellent 510 can be approximately ¼ teaspoon to 1 teaspoon, less than ¼ teaspoon, more than 1 teaspoon, or some other volume. The emanated insect repellent, shown as emanated insect repellent 605 in FIG. 6, among others, can be a vaporized, gaseous, atomized, or other form of the insect repellent 510 that can emanate from the insect repellent device 100 to repel insects (e.g., to keep insects away, to kill insects) within an area surrounding the insect repellent device 100 or a user (e.g., an individual wearing the insect repellent device 100 or otherwise operating the insect repellent device 100).

The reservoir 115 can include at least one container 120 and at least one dosing member 125. The reservoir 115 can include the container 120 at least partially covered (e.g., enveloped, surrounded) by the dosing member 125. For example, the container 120 can be positioned within the dosing member 125 or the dosing member 125 can be wrapped around the container 120. The container 120 can contain an amount (e.g., ¼ to 1 teaspoon) of the insect repellent 510. The insect repellent 510 can be or include highly volatile synthetic pyrethroid esters or other insecticide substances. For example, the insect repellent 510 can include volatile insecticides, volatile insect repelling natural oils, volatile insect growth regulators, or some mixture or combination thereof. The insect repellent 510 can include, for example, one or more compounds such as metofluthrin. For example, the insect repellent 510 be or include a 4% metofluthrin insecticide or some other metofluthrin solution with a greater than 4% or less than 4% concentration. In addition to or instead of a metofluthrin solution, the insect repellent 510 can be or include oil of lemon-eucalyptus, transfluthrin, nootkatone, citronella, lemongrass, necronome, linalool, and combinations thereof. The insect repellent 510 can have a liquid form, a semi-liquid form (e.g., a liquid with solids such as beads or pellets mixed therein), a semi-solid form (e.g., a gel form), or a solid form (e.g., beads, pellets, or other some other form). The insect repellent 510 can include a first form associated with a first temperature and a second form associated with a second temperature. For example, the insect repellent 510 can include a solid or semi-solid form at a first temperature (e.g., room temperature, 20° C., 25° C., or some other temperature) and a liquid or semi-liquid form at a second temperature (e.g., 30° C., 35° C., or some other temperature that is elevated relative to the first temperature). The insect repellent 510 can change form (e.g., form semi-solid to liquid) when exposed to heat, such as the heating energy 205 generated by the heating element 105.

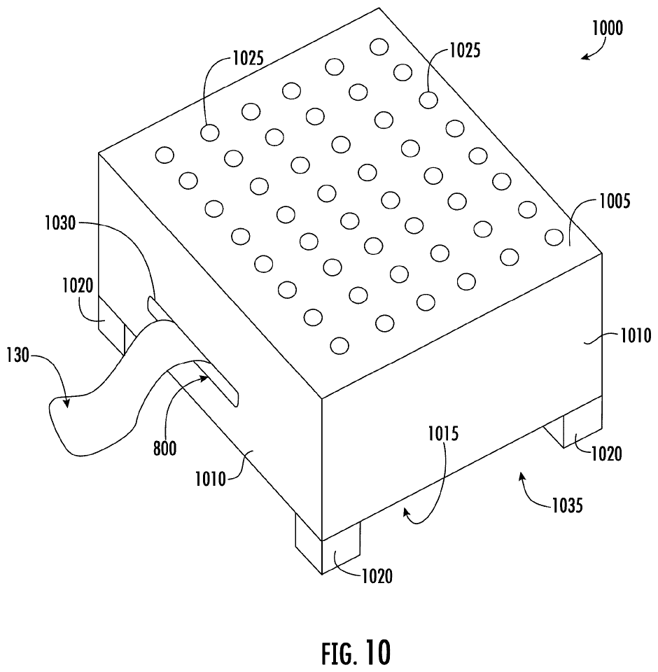

The container 120 can include an outer member 515. The container 120 can define a cavity 505. The outer member 515 can surround the cavity 505. For example, the outer member 515 can be a polymeric membrane, rubberized membrane, or a membrane composed of some other material to form the cavity 505 of the container 120. For example, the outer member 515 can be a flexible or malleable bag, pouch, or sack. The insect repellent 510 can be contained (e.g., stored, housed, retained) within the cavity 505 of the container 120 with the outer member 515 sealed to prevent the insect repellent 510 from exiting the cavity 505. The outer member 515 can include a pouch form factor, a cylindrical or disc form factor, a spherical form factor, or some other form factor. The outer member 515 can include a thin wall thickness (e.g., less than 2 mm, less than 5 mm, or some other thickness). The container 120 can be or include a rigid or flexible material. For example, the container 120 can be made of a rigid material, such as a polymeric, metallic, or composite material that remains rigid (e.g., does not compress) as the insect repellent 510 is dispensed from the cavity 505. The container 120 can be made of a flexible material, such as a polymeric, synthetic, organic, rubberized, or other material that can be compressed. For example, the container 120 can be compressed to facilitate the dispensing of the insect repellent 510. The container 120 can be compressed as a consequence of the dispensing of the insect repellent 510. For example, the container 120 can contract (e.g., shrink, reduce in size) as the insect repellent 510 exits the cavity 505. In other examples, the container 120 can be formed from two or more separate layers, components, or members that, when combined, form the cavity 515, such as the embodiment shown in FIGS. 8 and 9 and discussed below.

The container 120 can include at least one opening 520 (e.g., a container opening) formed in the outer member 515 of the container 120 to selectively allow an amount of the insect repellent 510 to be dispensed from the cavity 505. The opening 520 can be one or more an apertures, holes, vents, one-way valves, or perforations that can allow the insect repellent 510 to flow out of the cavity 505 of the container 120. For example, the opening 520 can facilitate an amount of dispensed insect repellent 600 can move (e.g., flow, pass) from the cavity 505 through the opening 520 and onto the dosing member 125. As noted above, the insect repellent 510 can repel insects with the insect repellent 510 emanated from the insect repellent device 100. The insect repellent 510 can be emanated from the insect repellent device 100 as emanated insect repellent 605 with the insect repellent 510 dispensed from the cavity 505 of the container 120 via the opening 520. The insect repellent 510 can continue to be dispensed from the container 120 to facilitate the emanation of the insect repellent 510 from the device 100 while the opening 520 is open (e.g., uncovered, revealed, unobstructed, unblocked). The emanation of the insect repellent 510 can be stopped or reduced (e.g., slowed, decreased) with the opening 520 of the container 120 closed (e.g., covered, obstructed, blocked) such that the insect repellent 510 cannot exit the cavity 505 via the opening 520.

The container 120 can be configured to selectively provide an amount of substance to the dosing member 125. For example, the container 120 can include the opening 520 (e.g., a container opening) formed in an outer member 515 of the container 120 to allow an amount of the insect repellent 510 to pass from a container 120 to the dosing member 125. For example, dispensed insect repellent 600, which can be a portion or substantially an entirety of the insect repellent 510 within the container 120, can exit the cavity 505 of the container 120 via the opening 520 and be received by (e.g., be absorbed by, contact, touch) the dosing member 125. As noted above, the dosing member 125 can at least partially surround or cover the container 120. For example, dosing member 125 can be positioned at least partially around the container 120 such that the dispensed insect repellent 600 can be received by the dosing member 125. In some examples, the dosing member 125 can be one or more sheets, layers, or plies (e.g., a dosing layer) of absorbent material positioned atop the container 120 or the opening 520 of the container 125 in order to receive the dispensed insect repellent 600. As depicted in FIGS. 5-6, among others, the opening 520 of the container 120 can be positioned on a top of the container 120. In other examples, the dosing member 125 or a portion thereof can be positioned below the container 120 and/or in between a top of the heating element 105 and a top of the reservoir 115. The dosing member 125 can be positioned directly adjacent the container 120 (e.g., above the container 120 or between the container 120 and the heating element 105) such that the dispensed insect repellent 600 can exit the container 120 via the opening 520 and be received by the dosing member 125. For example, a gravitational force can cause the insect repellent 510 to gradually (e.g., at a metered rate determined by a diameter or other dimension of the opening 520) exit the opening 520. The opening 520 can be positioned on a side of the container, on a top of the container, or in some other position. For example, the opening 520 can be positioned on a top of the container 120, and the insect repellent 510 can exit the cavity 505 of the container 120 via the opening based on some pressure differential between the cavity 505 and a surrounding (e.g., ambient) environment, based on a capillary action, or otherwise.

The dosing member 125 can be or include an absorbent or semi-absorbent material. The dosing member 125 can be or include a wicking material to facilitate the dispersion or emanation of the insect repellent 510. For example, the dosing member 125 can include a fibrous material, non-fibrous material, organic material, semi-organic material, polymeric material, or some other material that can be configured to draw the insect repellent 510 from the cavity and/or disperse the dispensed insect repellent 600 (e.g., an amount of the insect repellent 510 dispensed from the cavity 505 of the container 120) via capillary action or some other wicking action. The dosing member 125 can be an absorbent or semi-absorbent material that can be at least partially saturated with the dispensed insect repellent 600. For example, the dispensed insect repellent 600 can be absorbed or partially absorbed by the dosing member 125 with the insect repellent 510 in a liquid or semi-liquid state or form. The dosing member 125 can include one or more grooves, channels, or passageways configured to facilitate the dispersion or movement of the dispensed insect repellent 600 with the insect repellent 510 having solid or semi-solid (e.g., gel) form. For example, the dosing member 125 can include at least one groove, channel, or passageway through which dispensed insect repellent 600 can slide or move in a direction away from the opening 520 (e.g., towards a periphery or outer region of the insect repellent device 100).

The dosing member 125 can disperse or emanate the amount substance provided by the container 120. For example, the dosing member 125 can disperse the dispensed insect repellent 600 to facilitate the emanation of the dispensed insect repellent 600. The dosing member 125 can include a wicking material (e.g., polyester, wool, bamboo, synthetic fibers, organic fibers, or some other material) that can draw the dispensed insect repellent 600 away from the opening 520 of the container 120. For example, the dosing member 125 can wick the dispensed insect repellent 600 via capillary action or some other wicking action. The dosing member 125 can become at least partially saturated with the insect repellent 510. For example, the dosing member 125 can be or include an absorbent or semi-absorbent material (e.g., cotton, wool, natural fibers, synthetic fibers, or some other material) to absorb or partially absorb the dispensed insect repellent 600. Whether the dosing member 125 wicks or absorbs the dispensed insect repellent 600, the dosing member 125 can disperse the dispensed insect repellent 600 over a relatively large surface area (e.g., relative to the diameter or another dimension of the opening 520). For example, the dosing member 125 can cause the dispensed insect repellent 600 to be spread or dispersed over an entire width or length of the insect repellent device, over an entire length or width of the heating element 105, or some dimension.

The dispensed insect repellent 600 can be dispensed over a larger surface area by the dosing member 125 to facilitate the emanation of the dispensed insect repellent 600 from the insect repellent device. For example, the reservoir 115 can be coupled with (e.g., positioned adjacent to) the heating element 105 such that the generated heating energy 205 can be directed to or radiate to the reservoir 115. In particular, the heating element 105 can provide the generated heating energy 205 to the dosing member 125 of the reservoir 115 with the heating element 105 activated (e.g., the chemical compound 200 undergoing an exothermic reaction or some other heat-generating reaction). For example, the generated heating energy 205 can be provided to the dosing member 125 with the dispensed insect repellent 600 dispersed throughout the dosing member 125. The heating energy 205 can promote an evaporation, vaporization, atomization, or other reaction of the dispensed insect repellent 600 to create the emanated insect repellent 605. For example, when exposed to the generated heating energy 205, the dispensed insect repellent 600 can be vaporized and can emanate from the insect repellent device 100 to repel insects near the insect repellent device 100. The heating energy 205 can promote, expedite, or cause the vaporization, evaporation of the dispensed insect repellent 600. For example, the dispensed insect repellent 600 can only vaporize or evaporate when heated to a sufficient temperature or otherwise exposed to sufficient heating energy (e.g., the generated heating energy 205). In other examples, the dispensed insect repellent 600 can evaporate or be vaporized at a quicker rate with the dispensed insect repellent 600 exposed to the generated heating energy 205.

The insect repellent device 100 can include the activating member 130 to selectively dispense the insect repellent 510 from the cavity 505 of the container 120. For example, the activating member 130 can dispense an amount of insect repellent 510 from the cavity 505 of the container 120 to the dosing member 125. As depicted in FIGS. 5-7, among others, the activating member 130 can include at least one pull-tab 215. The pull-tab 215 can include a first end 525 (e.g., segment, portion, side) and a second end 530 (e.g., segment, portion, side). The first end 525 can extend away from the pouch reservoir 115, the container 120, and the dosing member 125. The second end 530 can be coupled with the container 120. For example, the second end 530 can be coupled with the outer surface 515 of the container 120 to cover the opening 520. The second end 530 of the pull-tab 215 can be coupled with the container 120 over the opening 520 such that the insect repellent 510 cannot flow into from the cavity 505 of the container 120 via the opening 520 with the second end 530 coupled with the container 120. For example, the second end 530 can be coupled with the container 120 via an adhesive or with a gasket or seal positioned between the second end 530 and the container 120 such that the insect repellent 510 (e.g., liquid, gel, or other insect repellent) cannot pass from the cavity 505 to an external environment (e.g., to the dosing member 125 at least partially surrounding the container 120. The coupling of the second end 530 of the pull-tab 215 and the container 120 can prevent the insect repellent 510 from flowing from the container 120 to the dosing member 125, which can further prevent the insect repellent 510 from being absorbed by or emanating the insect repellent 510 from the insect repellent device 100. For example, the insect repellent can be contained within the container 120 and can be prevented from exiting the container 120 because the second end 530 is obstructing, blocking, or otherwise preventing the insect repellent 510 from leaving the container 120.

The pull-tab 215 can be removably coupled with the container 120. For example, the second end 530 of the pull-tab 215 can be detachably coupled with the container 120 such that the pull-tab 215 can at least partially separate from the container 120 to allow the insect repellent 510 to flow from the cavity 505 of the container 120 via the opening 520. For example, as depicted in FIG. 5, among others, the pull-tab 215 can be in a first position with the second end 530 coupled with the container 120 and covering the opening 520 to prevent the insect repellent 510 from exiting the cavity 505 via the opening 520. The insect repellent 510 within the cavity 505 can be sealed and unexposed to an external environment with the pull-tab 215 in the first position. The pull-tab 215 can be moved from the first position to a second position. For example, the pull-tab 215 can be moved from the first position to the second position, where the second position can include the second end 530 of the pull-tab 215 at least partially separated from the container 120 or at least partially separated from the opening 520. As depicted in FIG. 6, among others, the second end 530 of the pull-tab 215 can be moved away from or separated from the opening 520 of the container 120 with the pull-tab 215 in the second position. For example, the pull-tab 215 can move in the direction 405 or some other direction to move or separate the second end 530 from the opening 520. An amount of insect repellent 600 (e.g., at least a portion of the insect repellent 510 within the cavity 505, can exit the cavity 505 via the opening 520 with the pull-tab 215 in the second position. For example, a user or operator can grasp the first end 525 of the pull-tab 215 and apply a force (e.g., a tensile force, a pulling force) to the pull-tab 215 in the direction 405 to separate or move the second end 530 from the opening 520 to allow the amount of insect repellent 600 to move from the cavity 505 to the dosing member 125 to consequently produce (e.g., via emanation of the dispensed amount of insect repellent 600) emanated insect repellent 605 (e.g., an insect repellent vapor). The user or operator can push the first end 525 of the pull-tab 215 in a second direction 410 move the second end 530 over the opening 520 to prevent insect repellent 510 from being dispensed from the cavity 505 of the container 120 and to consequently stop or prevent the dosing member 125 from wicking, absorbing, or emanating the insect repellent.

The activating member 130 can include some other mechanism, component, or device to selectively allow the insect repellent 510 to be dispensed from the cavity 505 via the opening 520. For example, the activating member 130 can include a screw-actuated valve that can prevent the insect repellent 510 from flowing through the opening 530 with a screw in a tightened position and allow the insect repellent fluid 510 to flow through the opening 530 with the screw in a loosened position. The activating member 130 can include a rotatable disc or knob that can prevent the insect repellent 510 from flowing through the opening 520 with a disc in a first rotational position and allow the insect repellent 510 to flow through the opening 520 with the disc in a second rotational position. The activating member 130 can include a pin, tack, or other sharp object to selectively pierce the container 120 and to create the opening 520. For example, rather than covering a pre-existing opening, the activating member 130 can include a sharp object to pierce the container 120 and create the opening 520 to allow the amount of insect repellent 600 to be dispensed from the cavity 505. The sharp object of the activating member 130 can be actuated by a user depressing a portion of the activating member 130 to pierce the container 120.

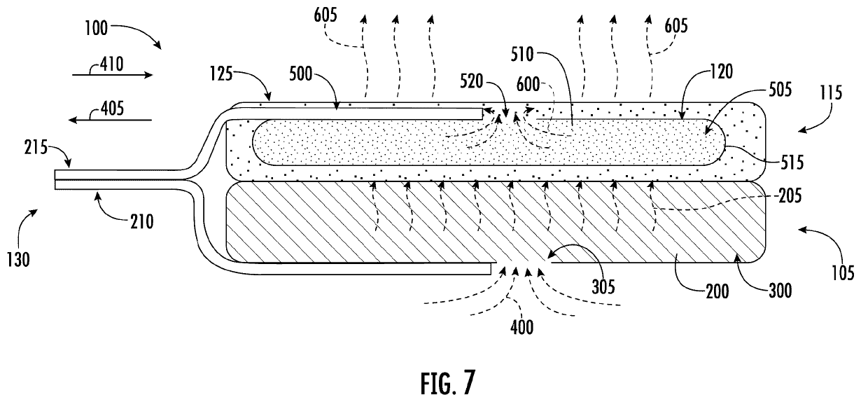

The reservoir 115 can be coupled with the heating element 105. For example, the reservoir 115 can be attached to (e.g., adhered to, joined with) the heating element 105 with an adhesive (e.g., glue, double-sided tape, or some other adhesive). The heating element 105 and the reservoir 115 can be integrally formed. For example, the heating element 105 and the reservoir 115 can be contained (e.g., housed, positioned, located) within an outer housing, shell, pouch, or other member of the insect repellent device 100. As depicted in FIG. 7, among others, the reservoir 115 can be positioned on top of (e.g., stacked on) the heating element 105 to form the insect repellent device 100. The insect repellent device 100 can have a pouch form factor such that a width and length of the insect repellent device 100 can be substantially (e.g., +80%) greater than a thickness of the device 100 with the insect repellent device including the heating element 105 coupled with the reservoir 115. In other examples, the insect repellent device 100 can include a block or brick form factor. In yet other examples, the insect repellent device 100 can include a disc form factor, an arcuate form factor, a slender form factor (e.g., a band), or some other form factor. In other examples, the insect repellent device 100 can be or include a housing (e.g., a housing 1000 as depicted in FIG. 10), where the housing can have a rigid rectangular, ovular, or some other form factor.

The activating member 130 can include the pull-tab 210 coupled with the pull-tab 215. For example, the pull-tab 210 and the pull-tab 215 can be the same pull-tab, integrally formed, or otherwise coupled together (e.g., molded together, sewn together, adhered together). As depicted in FIG. 7, for example, the pull-tab 210 can be joined with the pull-tab 215 to form the activating member 130. The pull-tab 210 can be configured to selectively open the opening 305 (e.g., the heating element opening). For example, a user can apply a force (e.g., a tensile force, a pulling force) in the direction 405 to cause the pull-tab 210 to move from a first position where the opening 305 is closed (e.g., to prevent air from entering the cavity 300 via the opening 305) by the pull-tab 210 to a second position where the pull-tab 210 moves away from the opening 305 to allow air to flow into the opening 305 to initiate an exothermic reaction of the chemical compound 200. The pull-tab 215 can be configured to selectively open the opening 520 (e.g., the container opening). For example, a user can apply a force (e.g., a tensile force, a pulling force) in the direction 405 to cause the pull-tab 215 to move from a first position where the opening 520 is closed (e.g., where insect repellent 510 cannot exit the cavity 505 of the container 120) by the pull-tab 215 to a second position where the pull-tab 215 moves away from the opening 520 to allow insect repellent 510 to exit the cavity 505 via the opening 520. A user can pull the activating member 130 in the direction 405 to simultaneously move the pull-tab 210 to the second position to open the opening 305 and activate the heating element 105 and move the pull-tab 215 to the second position to open the opening 520 to dispense the insect repellent 510 from the container 120. Because the insect repellent 510 can be dispensed at the substantially the same time (e.g., within 5 seconds) as the heating element 105 is activated, the dispensed insect repellent 600 can be emanated by the heating energy generated by the heating element 105 to create the emanated insect repellent 605.

Although shown in FIG. 7, among others, as two pull-tabs joined together, the activating member 130 can be a single pull-tab that simultaneously opens the opening 305 to activate the heating element 105 and opens the opening 520 to dispense the insect repellent 510. In other embodiments, the activating member can be a pincer or clamp that can simultaneously pierce the pouch 110 of the heating element 105 and the outer member 515 of the container 120 to create the opening 305 and the opening 520, respectively. In other examples, the activating member 130 can be some other device, mechanism, or combination of multiple devices or mechanisms to simultaneously open or form the opening 305 and the opening 520. In various embodiments, the insect repellent device 100 can be activated to both dispense a dose of the insect repellent 510 to the dosing member 125 and initiate an exothermic reaction of the chemical compound 200 of the heating element 105 by a user activating (e.g., pulling, squeezing, actuating) a single activating member 130.

Referring now to FIG. 8, a cross-sectional view of an insect repellent device 800 is shown. The insect repellent device 800 includes a heating element 105 having multiple heating element 805 or multiple heating element layers 805. For example, rather than the heating element 105 including a single pouch 110 defining a single cavity 200 containing a single volume exothermic material 300, the heating element 105 can include multiple heating elements 805 (e.g., heating element layers 805). Each heating element 805 can include a pouch 810 defining a cavity 200, where each cavity of each pouch 810 can include an amount of exothermic material 300. The heating elements 805 can be stacked together such that one heating element 805 forms a bottom of the insect repellent device 800, while another different heating element 805 is positioned proximate to (e.g., against) the reservoir 115. As shown in FIG. 8, among others, the insect repellent device 800 can include three heating elements 805 stacked together. In other embodiments, the insect repellent device 800 can include two heating elements 805, four heating elements 805, or more than four heating elements 805. Each of the heating elements 805 can be fluidly coupled so that air that permeates one heating element 805 (e.g., the bottom-most heating element 805) can flow to the other heating elements 805 in the stack. For example, the heating elements 805 can be fluidly coupled through one or more passageways 835 that permit the flow of air from a cavity 200 of one heating element 805 to a cavity 200 of another heating element 805. In such embodiments, the pouches 810 of the heating elements can be air-impermeable such that air can enter the cavity 200 only through the passageway 835 or—in the case of an outer-most heating element 805—through the opening 305 after the pull-tab 210 of the activating member 130 has been actuated.

By stacking multiple heating elements 805 together, a temperature of the collective heating element 105 can increase to a desirable temperature (e.g., 90° C., 80-100° C., greater than 100° C., less than 80° C., or some other temperature) and can remain at said desirable temperature for a desirable duration (e.g., 2-4 hours, less than 2 hours, or more than 2 hours). During operation, air (e.g., oxygen) can readily flow into an outer-most (e.g., a bottom-most heating element 805 via the opening 305. Air may flow from the outer-most heating element 805 to the next heating element 805 in the stack of heating elements 805 (e.g., an intermediate heating element 805) via one or more passageways 835, but at a rate that is lesser than a rate at which air enters the cavity 200 of the outer-most heating element 805. Moreover, air may flow from the intermediate heating element 805 to another heating element 805 (e.g., an inner-most heating element 805) via one or more passageways 835, but at a rate that is lesser than the rate at which air enters the cavity 200 of the intermediate heating element 805. In this way, an exothermic reaction of the outer-most heating element 805 occurs at a faster rate and for a shorter duration than an exothermic reaction of the intermediate heating element 805. Likewise, an exothermic reaction of the intermediate heating element 805 occurs at a faster rate and for a shorter duration than an exothermic reaction of the inner-most heating element 805. Collectively, the heating elements 805 reach a target temperature range quicker and maintain the target temperature range for a longer duration by combining and staggering the exothermic reactions of each heating element 805.

The insect repellent device 800 also includes a dosing member 125 formed as at least one dosing layer 810. The dosing layer 810 can be one or more sheets, plies, or layers of a wicking material positioned on an outer side (e.g., a top side) of the container 120. The insect repellent device 800 includes the container 120 formed by two or more container layers 820. The container layers 820 can each be one or more sheets, plies, or layers of a material that is impermeable to the insect repellent material 515. For example, the container layers 820 can be plastic sheets or some other polymeric material that prevents oxygen, insect repellent material 515 or other fluids from passing therethrough. Two container layers 820 can be stacked together with an amount of insect repellent 515 positioned therebetween. For example, a volume (e.g., ¼ teaspoon) of insect repellent material 515 can be positioned on an outer-most side (e.g., a top side) of an inner-most (e.g. a bottom) container layer 820. An outer-most (e.g., a top) container layer 820 can be positioned on the outer-most side of the inner-most container layer 820 with the volume of insect repellent material 515 between the outer-most and inner-most container layers 820. The outer-most and inner-most container layers 820 can be joined together (e.g., crimped, melded, sealed, or otherwise joined to create a substantially impermeable bond) to trap the insect repellent material 515 within a cavity 825 between the two container layers 820. In this way, the cavity 825 of the container 120 can be formed by joining the two container layers 820 together with the insect repellent material positioned between them. For example, the volume of insect repellent material 515 can be positioned proximate a center of the container layers 820, while the two container layers 820 can be joined together proximate a periphery of the container layers or in some other position radially outward of the volume of insect repellent material 515.

The dosing layer 810 can be positioned on an outer-most side (e.g., a top side) of the outer-most container layer 820. The outer-most container layer 820 can include an opening 830 (e.g., an aperture, a hole, a passageway) to allow insect repellent material 515 to exit the cavity 825. Specifically, the insect repellent material 815 can exit the cavity and be received by (e.g., be absorbed by) the dosing layer 815. The pull-tab 215 of the activating member 130 can be positioned between the dosing layer 815 and the opening 830 of the outer-most container layer. When the activating member 130 is actuated, the pull-tab 215 separates from the opening 830. With the pull-tab 215 separated from the opening (e.g., with the pull-tab 215 in an open position), the insect repellent material 515 can be dispensed form the cavity 825 and received by the dosing 815. The dispensed insect repellent material 515 can then be emanated from the dosing layer 815 in a manner substantially similar to that described with respect to FIGS. 5-7.

Referring now to FIG. 9, an insect repellent device 900 is shown. The insect repellent device 900 includes an insulative layer 905. In other respects, the insect repellent device 900 can be similar to the insect repellent device 800 (e.g., by having multiple heating elements 805, by having a container 120 formed by container layers 820, or otherwise), as is depicted in FIG. 9. In other embodiments, the insect repellent device 900 can be otherwise similar to the insect repellent device 100 or some other insect repellent device. The insulative layer 905 can be positioned substantially around the insect repellent device (e.g., the insect repellent device 800). For example, the insulative layer 905 can be positioned around the heating element 105 and the reservoir 115 of the insect repellent device. The insulative layer 905 can be a thermally insulative layer. For example, the insulative layer 905 can act to retain heat energy within the insect repellent device (e.g., within the heating element 105) and to prevent heat energy from escaping to an outer environment. By retaining heat, the insulative layer 905 can aid in maintaining a target temperature range of the heating element 105, which can further facilitate the emanation of insect repellent material 515 from the insect repellent device. The insulative layer 905 can be or include a thermally reflective material (e.g., a thermally reflective foil) to reflect heat energy inward toward the insect repellent device. The insulative layer can be or include a fiber glass material, a composite material, an organic material, or some other material to reduce a transfer of heat through the insulative layer 905.

The insulative layer 905 includes at least one first opening 910 and at least one second opening 915. The first opening 910 can be positioned adjacent the dosing member 125 (e.g., the dosing layer 815) of the insect repellent device. For example, the first opening 910 of the insulative layer 905 can permit insect repellent to be emanated from the insect repellent device. The first opening 910 can be a relatively large opening that is substantially (e.g., ±20%) the same size as an outer surface of the dosing member 125. In other examples, the insulative layer 905 includes multiple first openings 910 rather than a single larger first opening 910. The second opening 915 can be a slot, slit, space, or other opening to allow the activating member 130 to extend from the insect repellent device and through the insulative layer 905 so as to be accessible by a user from outside the insulative layer 905. For example, the insulative layer 905 can include multiple second openings 915, including one for the pull-tab 210 and one for the pull-tab 215. The insulative layer 905 can be air-permeable. For example, air can pass through the insulative layer 905 to facilitate the exothermic reaction of the heating element 105. Accordingly, the insulative layer 905 can be a porous material. In some examples, the insulative layer 905 can include additional openings (e.g., apertures, slots, slits, or other openings) proximate the heating element 105 to provide an increased flow of air to the heating element 105 to expediate or further facilitate an exothermic reaction of the heating element.

The insect repellent device 100, the insect repellent device 800, the insect repellent device 900, the insect repellent device 1000, or some other insect repellent device can be a wearable insect repellent device. For example, the insect repellent device 100 can be flexible, pliable, or bendable such that the insect repellent device can be curved to match a curvature of a user's arm, wrist, leg, torso, or other appendage or part. The insect repellent device 100 can be coupled with a band (e.g., a watch band) so that the device 100 can be worn on the wrist of a user. The insect repellent device 100 can include a non-toxic adhesive layer on an outer surface (e.g., a bottom surface of the heating element 105) such that the device 100 can be applied directly to the skin of a user. For example, the device 100 can be applied to an arm of a user as a patch. In such examples, the insect repellent device 100 or a part thereof (e.g., the pouch 110 of the heating element 105) can include at least one thermally insulative or reflective layer to prevent the generated heating energy 205 from radiating into or burning the skin of the user. The insect repellent device 100 can include a clip, clasp, buckle, hasp, hook, or other device to attach the insect repellent device 100 to an article of clothing, bag, or other accessory of a user.

The insect repellent device 100, the insect repellent device 800, the insect repellent device 900, the insect repellent device 1000, or some other insect repellent device can be configured for one-time use operation. For example, the heating element 105 can include the chemical compound 200 that can be consumed during the exothermic reaction such that the chemical compound 200 reacts to produce some other substance that can no longer be used to generate heating energy via an exothermic reaction, for example. The exothermic reaction of the chemical compound 200 can continue for a duration of two hours, from one to two hours, greater than two hours, less than one hour, or for some other amount of time. The insect repellent 510 can be dispensed from the container 120 and substantially vaporized or evaporated such that little to no insect repellent 510 remains in the container or within the dosing member 125. For example, the dispensing of the insect repellent 510 from the container 120 via actuation of the pull-tab 215 or some other activating device can cause substantially (e.g., 95% of the insect repellent 510 to be emanated as the emanated insect repellent 605 such that little to no insect repellent 510 remains. The insect repellent 510 can be substantially emanated during the exothermic reaction of the chemical compound 200 such that when the exothermic reaction of the chemical compound 200 ceases, the insect repellent 510 can be substantially consumed.

The insect repellent device 100, the insect repellent device 800, the insect repellent device 900, or some other insect repellent device can be recyclable, biodegradable, or otherwise constructed from environmentally friendly materials. For example, the insect repellent device 100 (or any of the other insect repellent devices discussed herein) can be recyclable such that portions of the device 100 or the device 100 in its entirety can be recycle after use. The heating element 105, including the pouch 110 and the pull-tab 210, among other components, can be or include an organic or natural fibrous material or a recyclable polymeric material. The reservoir 115, including the container 120 and the dosing member 125 can be or include organic or natural fibrous materials, or recyclable polymeric material. For example, both the heating element 105 and the reservoir 115 can be recycled after the exothermic reaction of the chemical compound 200 and/or the emanation of the insect repellent 510 concludes.

The insect repellent device 100, the insect repellent device 800, the insect repellent device 900, or some other insect repellent device can include or be positioned within an outer cover. For example, as depicted in FIG. 10, among others, the insect repellent device 800 (or any of the other insect repellent devices discussed herein) can include a housing 1000. The housing 1000 cover can be a case, housing, package, pouch, holder, or other outer cover. The housing 1000 can define a cavity (e.g., an interior chamber). The insect repellent device 100 can be placed or inserted within the cavity of the outer cover so that the insect repellent device 100 can be completely or partially within or enclosed by the outer cover. The housing 1000 can include a top 1005, at least one side 1010, a bottom 1015, at least one foot 1020, at least one vent aperture 1025, and at least one activator opening 1030. The foot 1020 can extend from the bottom 1015 of the housing 1000. For example, as depicted in FIG. 10, the housing 1000 can include multiple feet 1020 extending or protruding from the bottom 1015 (e.g., one foot 1020 at each corner of the bottom 1015 of a rectangular housing 1000). The foot 1020 can elevate the housing 1000 from a surface upon which the foot 1020 rests. Put another way, the foot 1020 can create an opening 1035 (e.g., a gap, a space, a void) between the bottom 1015 of the housing 1000 and a surface upon which the housing 1000 rests. The opening 1035 can permit air to flow toward the bottom 1015 of the housing 1000. For example, the bottom 1015 can include (e.g., define, form) at least one vent aperture 1025 (not shown in FIG. 10) or some other opening to allow air to flow into the cavity of the housing 1000 through the bottom 1015. During operation of the insect repellent device 100, for example, air can flow through the vent aperture 1025 of the bottom 1015 of the housing 1000 via the gap 1035 to activate the heating element 105 or to facilitate an exothermic reaction associated therewith.

The housing 1000 can include vent apertures 1025 positioned on (e.g., defined by, formed in) the top 1005 of the housing 1000. For example, as depicted in FIG. 10, the housing 1000 includes multiple vent apertures 1025 positioned on the top 1005 of the housing to allow dispensed insect repellent 600 to be emanated through the top 1005 of the housing 1000. That is, the emanated insect repellent 605 travels (e.g., is dispersed through, emanates through) the vent apertures 1025 in the top 1005 of the housing 1000. The vent apertures 1025, whether defined by the top 1005 of the housing 1000, defined by the bottom 1015 of the housing, or otherwise positioned on or defined by the housing, can include a circular shape, a rectangular shape, some other shape (e.g., arcuate slots, diamonds, etc.), or some combination of shapes. In other embodiments, the top 1005 or bottom 1015 of the housing 1000 can include a mesh or porous screen through which air or emanated insect repellent 605 can pass in a relatively unobstructed manner. The housing 1000 can include the activator opening 1030, shown as slot 1030, formed in (e.g., defined by, positioned on) the side 1010 of the housing 1010. The slot 1030 can be sized to allow the activating member 130 of the insect repellent device 130 to extend from the cavity of the housing 1000, through the side 1010 of the housing 1000, and to an exterior so that a user can grasp the activating member 130 with a remainder of the insect repellent device 100 positioned within the housing 1000. Put another way, the slot 1030 can provide for the activation of the insect repellent device while the insect repellent device 100 is enclosed within the housing 1000. In other embodiments, the slot 1030 or some other activator opening 1030 can be defined by another portion of the housing 1000 (e.g., the bottom 1015, the top 1005, or otherwise).

The housing 1000 can be a temporary (e.g., disposable) package such as a plastic pouch, a vacuum-sealed bag, or other package configured to cover the insect repellent device 100 prior to use (e.g., activation) of the insect repellent device 100 (or any other insect repellent device discussed herein, for example). For example, the housing 1000 can protect the insect repellent device 100 from damage or inadvertently being activated (e.g., because of damage) during transport or handling of the insect repellent device. The housing 1000 can be a holder within which the insect repellent device 100 can be placed during use of the insect repellent device 100. For example, the housing 1000 can be a holder to hold (e.g., retain, clamp, grip, grasp, fix, or otherwise hold) the insect repellent device 100 with the insect repellent device 100 activated or in operation. In this way, the insect repellent device 100 can be positioned within the housing 1000 during operation so that a user does not come into direct contact with the insect repellent device 100. For example, during operation the dosing member 125 may be saturated with dispensed insect repellent 600 and/or the heating element 105 may be at an elevated temperature. By enclosing the insect repellent device 100 within the housing 1000, the user may avoid direct contact (e.g., contact to a user's skin) with the dispensed insect repellent 600 or activated heating element 105. The housing 1000 can include a hinge, a door, removable panel, or some other mechanism to provide selective access to the cavity of the housing 1000 to place an as yet un-activated insect repellent device 1000 within the cavity of the housing 1000 or to remove a spent insect repellent device 100 from the cavity of the housing 1000. In other embodiments, the housing 1000 can be or include an insulative material. For example, the housing 1000 can be made of a thermally insulative material or can include a thermally insulative layer positioned within the cavity of the housing 1000 to act as a thermal barrier that retains heat within the cavity of the housing 1000 and prevents heat energy from escaping the cavity of the housing 1000.

The housing 1000 can include an attachment mechanism (e.g., a clip, a velcro strap, a rubber gripper, an adhesive pad, external or internal threads, or some other attachment mechanism) configured to facilitate the attachment or coupling of the insect repellent device 100 with another object. For example, the attachment mechanism can attach or couple the insect repellent device 100 to article of clothing or other personal item (e.g., a bag, a backpack, a hat, or some other item) such that the outer member can hold the insect repellent device 100 near a user during use. The housing 1000 can itself be an article of clothing or an accessory. For example, the housing 1000 can be a strap to be worn on a wrist, arm, ankle, leg, or other appendage of a user. The housing 1000 can be reusable. For example, multiple insect repellent devices 100 can used with the same housing 1000. An insect repellent device 100 can be inserted into the housing 1000 and subsequently removed from the housing 1000 after use (e.g., after the exothermic reaction associated with the heating element 105 concludes or after the insect repellent 510 is consumed). A new insect repellent device 100 can be inserted into the housing 1000 and used to repel insects. Accordingly, a user can use multiple insect repellent devices 100 in series to prolong or extend a period of insect repellency.

As utilized herein, the terms “approximately”, “about”, “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” or “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other example embodiments, and that such variations are intended to be encompassed by the present disclosure.

Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other example embodiments without departing from scope of the present disclosure or from the spirit of the appended claims.

What is claimed is:

1. A non-powered insect repellent device, comprising:
a heating element comprising a chemical compound and a first opening, the chemical compound configured to generate heat via an exothermic reaction when exposed to air via the first opening;
a reservoir coupled with the heating element, the reservoir comprising a dosing member and a container, the container comprising a second opening and a cavity containing a volume of insect repellent material, the second opening configured to selectively fluidly couple the cavity with the dosing member; and
an activating member coupled with the heating element and the reservoir, the activating member configured to move between a closed position and an open position;
wherein, with the activating member in the closed position, the activating member is configured to prevent air from passing through the first opening to the chemical compound and to prevent the insect repellent material from being dispensed through the second opening to the dosing member;
wherein, with the activating member in the open position, air is permitted to pass through the first opening to the chemical compound to facilitate the exothermic reaction and the insect repellent material is dispensed through the second opening to the dosing member.

2. The device of claim 1, wherein the activating member includes a first tab coupled with the first opening and a second tab coupled with the second opening.

3. The device of claim 1, further comprising:
the heating element comprising a zinc-based chemistry.

4. The device of claim 1, wherein the heating element includes a plurality of stacked heating elements, the plurality of stacked heating elements fluidly coupled with each other, wherein an outer-most heating element of the plurality of stacked heating elements includes the first opening.

5. The device of claim 1, further comprising:
the exothermic reaction configured to cause the chemical compound to achieve a temperature of about 80 to 100° C. and maintain the temperature of about 80 to 100° C. for a 1 to 4 hours.

6. The device of claim 1, wherein the container further comprises an inner-most container layer coupled with an outer-most container layer, wherein the cavity is a pocket between the inner-most container layer and the outer-most container layer.

7. The device of claim 1, wherein the dosing member is a positioned on an outer side of the container, wherein with the activating member in the open position, the dosing member configured to draw the insect repellent material from the cavity via wicking action.

8. The device of claim 1, further comprising:
an housing defining a cavity, a plurality of vent apertures, and an activator opening, the plurality of vent apertures configured to permit a flow of air into the cavity of the housing, wherein the heating element and the reservoir are positioned within the cavity of the housing, wherein the activating member extends from the cavity of the housing through the activator opening, wherein the comprising an attachment mechanism configured to attach the insect repellent device to another object.

9. The device of claim 8, wherein the plurality of vent apertures are positioned on a bottom of the housing, the housing further comprising a plurality of feet, the plurality of feet configured to create an opening underneath a bottom of the housing to permit air to flow through the plurality of vent apertures into the cavity.

10. The device of claim 1, further comprising:
a thermally insulative layer including a third opening and a fourth opening, the insulative layer positioned substantially around the heating element and the reservoir, wherein the third opening is at least partially aligned with an outer surface of the dosing member, wherein the activating member extends at least partially through the fourth opening.

11. A non-powered insect repellent device, comprising:
a plurality of stacked heating elements, each including a chemical compound configured to generate heat via an exothermic reaction when exposed to air via a first opening;
a container thermally coupled with the plurality of stacked heating elements, the container including a cavity containing a volume of insect repellent material and a second opening, the insect repellant material including a metofluthrin solution;
a dosing layer including an absorbent material, the dosing layer coupled with the container and configured to receive at least a portion of the volume of insect repellent material from the cavity via the second opening;
a first activating member coupled to the first opening and configured to selectively permit air to flow to the outer-most heating element via the first opening to facilitate an exothermic reaction; and
a second activating member coupled to the second opening and configured to selectively dispense insect repellent material from the cavity to the dosing layer via the second opening.

12. The device of claim 11, wherein the first activating member is coupled with the second activating member.

13. The device of claim 11, further comprising:
the exothermic reaction configured to cause the chemical compound to achieve a temperature of about 80 to 100° C. and maintain the temperature of about 80 to 100° C. for a 1 to 4 hours.

14. The device of claim 11, wherein the container further comprises a first container layer coupled with a second container layer, wherein the cavity is a pocket between the inner-most container layer and the outer-most container layer.

15. The device of claim 11, wherein the dosing layer is a positioned on an outer side of the container, wherein with the activating member in the open position, the dosing layer configured to draw the insect repellent material from the cavity via wicking action.

16. The device of claim 11, further comprising:
a thermally insulative layer including a third opening and a fourth opening, the insulative layer surrounding at least a portion the heating element, the container, and the dosing layer, wherein the third opening is at least partially aligned with an outer surface of the dosing layer, wherein the activating member extends at least partially through the fourth opening.

17. A non-powered insect repellent device, comprising:
a housing defining a cavity;
a heating element including a chemical compound configured to generate heat via an exothermic reaction when exposed to air via a first opening;
a reservoir thermally coupled with the heating element, the reservoir including a dosing member, a container cavity containing a volume of insect repellent material, and a second opening, the dosing member positioned to receive at least a portion of the volume of insect repellent material from the container cavity via the second opening;
an activating member coupled to the first opening and the second opening, the activating member configured to selectively permit air to flow to the outer-most heating element via the first opening to facilitate an exothermic reaction and to selectively dispense insect repellent material from the container cavity to the dosing layer via the second opening; and
an insulative layer surrounding at least a portion of the heating element;
wherein the heating element, the reservoir, the insulative layer, and at least a portion of the activating member are positioned within the cavity of the housing.

18. The device of claim 17, further comprising:
the housing including a first plurality of vent apertures and an activator opening, the first plurality of vent apertures configured to permit a flow of air into the cavity of the housing to facilitate the exothermic reaction, wherein the activating member extends from the cavity through the activator opening, wherein the comprising an attachment mechanism configured to attach the insect repellent device to another object.

19. The device of claim 18, wherein the first plurality of vent apertures are positioned on a bottom of the housing, the housing further comprising a plurality of feet, the plurality of feet configured to create an opening underneath a bottom of the housing and configured to permit air to flow through the plurality of vent apertures into the cavity.

20. The device of claim 19, further comprising a second plurality of vent apertures positioned on a top of the housing, the second plurality of vent apertures configured to permit the emanated insect repellent material to exit the housing.
